(19) United States
(12) Patent Application Publication
(10) Pub. No.: US 2024/0255369 A1
(43) Pub. Date: Aug. 1, 2024

(54) DETERMINING AND CONTROLLING CABLE LOADING BASED ON MEASURED VIBRATION STATE

(71) Applicant: Knowix, LLC, Houston, TX (US)

(72) Inventor: Luis Padilla, Katy, TX (US)

(73) Assignee: Knowix, LLC, Houston, TX (US)

(21) Appl. No.: 18/421,415

(22) Filed: Jan. 24, 2024

Related U.S. Application Data
(60) Provisional application No. 63/481,993, filed on Jan. 27, 2023.

(51) Int. Cl. G01L 5/04

(52) U.S. Cl. CPC G01L 5/042

(57) ABSTRACT

The present disclosure is directed to systems and techniques for determining tension or loading of a cable based on vibration of the cable. For example, a method can include obtaining accelerometer measurements from one or more accelerometers associated with a cable. Based on the accelerometer measurements, a vibration state of the cable can be determined. An estimated loading associated with the cable can be determined based on the vibration state of the cable. For example, generating the estimated loading associated with the cable can be based on determining one or more changes in the vibration state of the cable. The estimated loading can be indicative of a tension of the cable. The estimated loading can be a magnitude value, a delta value, or a time-based value, among others. The estimated loading can be determined from accelerometers that are separate from the load path of the cable.

### CROSS-REFERENCE TO RELATED APPLICATIONS

This application claims the benefit of priority to U.S. Provisional Patent Application No. 63/481,993 filed Jan. 27, 2023, and entitled “DETERMINING AND CONTROLLING CABLE LOADING BASED ON MEASURED VIBRATION STATE,” the disclosure of which is herein incorporated by reference in its entirety and for all purposes.

### TECHNICAL FIELD

The present disclosure generally relates to line management, including in rope and cable systems. For example, aspects of the present disclosure are related to systems and techniques of determining and controlling tension and/or loading of a cable based on vibration of the cable.

### BACKGROUND

As used herein, the terms “cable”, “rope”, and “rope and cable” may be used interchangeably. A cable can be considered a tensile strength member, in that a cable can transmit tensile forces but not compressive forces. For example, flexible cables can be connected between two components and used to transmit a tensile force between the two components. Cables often include end-fittings configured to transmit a load. The assembly of an end-fitting and the portion of the cable to which it is attached can be referred to as a “termination.”

The usable lifetime of a cable can depend on various factors, including characteristics of the particular deployment of the cable and material properties of the cable itself. For example, cables can be used to perform various tasks, such as fastening, lowering, lifting, etc., of various objects. Cables can be used in various environments, such as maritime environments (e.g., where the cable may be at least partially submerged), land-based environments, indoor environments, etc. The usable lifetime of a cable can depend on the type(s) of loading cycle(s) imparted to the cable. For example, cyclical loads are often imposed on cables deployed in a maritime environment, and can cause accelerated fatigue in parts of the cable. Failure of a cable can have undesirable consequences, particularly a failure of a cable while under tension or load.

In addition to using loading information of a cable to measure or estimate fatigue, remaining usable lifetime, and/or various other safety-related characteristics, loading information of a cable can also be used to drive one or more cable management actions. For instance, different actions may be taken when a cable is in a loaded (e.g., tensioned) state as compared to when a cable is in an unloaded (e.g., non-tensioned state). Similarly, different actions may be taken when a cable is an overloaded state (e.g., current load exceeding one or more load threshold values) as compared to when a cable is not in an overloaded state (e.g., current load not exceeding one or more load threshold values). Load information of a cable can be utilized as discrete measurements corresponding to discrete points in time and/or can be utilized as a time-series of measurements corresponding to changes in load over a period of time.

### BRIEF SUMMARY

In some examples, systems and techniques are described for determining and controlling tension and/or loading of a cable based on vibration of the cable. For example, one or more accelerometers can be used to determine a vibration state of a cable.

According to at least one illustrative example, a method is provided, the method comprising: obtaining one or more accelerometer measurements from one or more accelerometers associated with a cable; determining, based on the one or more accelerometer measurements, a vibration state of the cable; and generating an estimated loading associated with the cable, based on the vibration state of the cable.

In another illustrative example, an apparatus is provided that includes a memory (e.g., configured to store data, such as virtual content data, one or more images, etc.) and one or more processors (e.g., implemented in circuitry) coupled to the memory. The one or more processors are configured to and can: obtain one or more accelerometer measurements from one or more accelerometers associated with a cable; determine, based on the one or more accelerometer measurements, a vibration state of the cable; and generate an estimated loading associated with the cable, based on the vibration state of the cable.

In another illustrative example, a non-transitory computer-readable medium is provided that has stored thereon instructions that, when executed by one or more processors, cause the one or more processors to: obtain one or more accelerometer measurements from one or more accelerometers associated with a cable; determine, based on the one or more accelerometer measurements, a vibration state of the cable; and generate an estimated loading associated with the cable, based on the vibration state of the cable.

In another example, an apparatus is provided, the apparatus including: means for obtaining one or more accelerometer measurements from one or more accelerometers associated with a cable; means for determining, based on the one or more accelerometer measurements, a vibration state of the cable; and means for generating an estimated loading associated with the cable, based on the vibration state of the cable.

In some aspects, generating the estimated loading associated with the cable comprises: generating an indication of a no-load state based on detecting a first vibration state of the cable; and generating an indication of a loaded state based on detecting a second vibration state of the cable.

In some aspects, generating the estimated loading associated with the cable is based on determining one or more changes in a vibration state associated with the cable.

In some aspects, generating the estimated loading associated with the cable comprises: generating an indication of a loaded state based on determining a first type of vibration behavior change between an initial vibration state of the cable and a subsequent vibration state of the cable; and generating an indication of a no-load state based on determining a second type of vibration behavior change between the initial vibration state of the cable and a subsequent vibration state of the cable, wherein the second type of vibration behavior change is different than the first type of vibration behavior change.

In some aspects, generating the estimated loading associated with the cable comprises: determining a first estimated loading associated with the cable at a first time; determining a second estimated loading associated with the cable at a second time after the first time; and generating an indication of a loading change between the first time and the second time.

In some aspects, the indication of the loading change between the first time and the second time is indicative of an increase or a decrease in loading associated with the cable.

In some aspects, the indication of the loading change between the first time and the second time is indicative of one or more of a percentage change in loading associated with the cable between the first time and the second time and a tension change associated with the cable between the first time and the second time.

In some aspects, generating the estimated loading associated with the cable comprises determining an estimated tension of the cable.

In some aspects, one or more tension estimates associated with the cable can be generated, wherein the one or more tension estimates are generated based on the vibration state of the cable.

In some aspects, the one or more accelerometer measurements comprises a plurality of accelerometer measurements, each respective accelerometer measurement included in the plurality of accelerometer measurements associated with a different time.

In some aspects, the vibration state of the cable comprises one or more of a change in vibration frequency over time and a change in vibration amplitude over time.

In some aspects, the method further comprises activating one or more sensors associated with the cable based on generating the indication of the loaded state; and deactivating the one or more sensors associated with the cable based on generating the indication of the no-load state.

In some aspects, the method further comprises: determining an elapsed time between generating the indication of the loaded state and generating the indication of the no-load state; and updating a first timer value using the elapsed time, wherein the first timer value is indicative of a time under load associated with the cable.

In some aspects, the one or more accelerometer measurements are obtained from one or more accelerometers detachably coupled to the cable.

In some aspects, the one or more accelerometers are not included in a load path associated with the cable.

In some aspects, the one or more accelerometer measurements are obtained from one or more accelerometers included in a sensor housing detachably coupled to the cable.

In some aspects, the one or more accelerometer measurements are obtained from one or more accelerometers included in the cable.

In some aspects, the one or more accelerometer measurements are obtained from one or more accelerometers included in an end termination of the cable.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 illustrates an example implementation of a system-on-a-chip (SoC), in accordance with some examples;

FIG. 2A illustrates an example of a fully connected neural network, in accordance with some examples;

FIG. 2B illustrates an example of a locally connected neural network, in accordance with some examples;

FIG. 3 is a flowchart illustrating an example process for determining estimated loading state information associated with a cable, in accordance with some examples; and

FIG. 4 is a block diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various aspects of the present disclosure will be described below with respect to the figures.

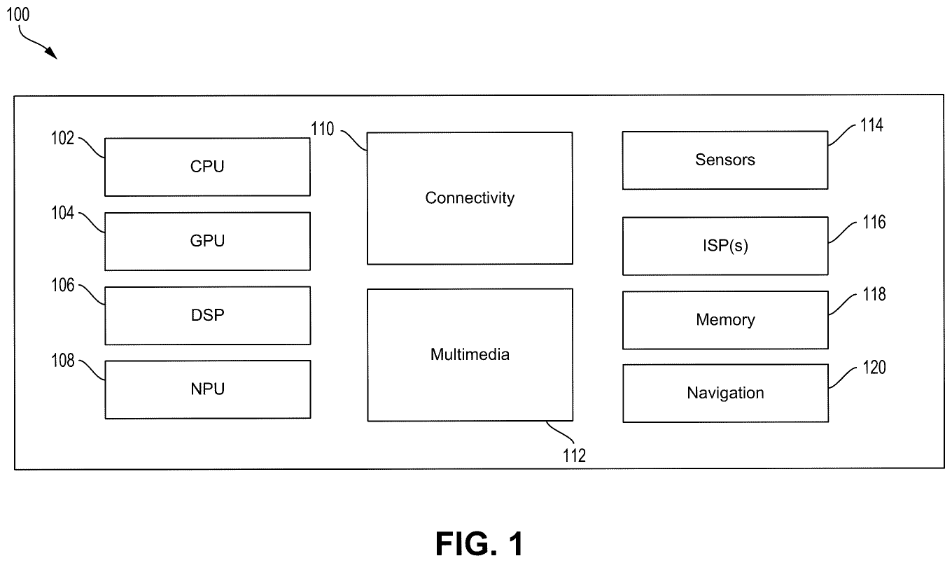

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform signal processing using machine learning techniques according to aspects of the present disclosure discussed herein. For example, SOC 100 and/or components thereof may be configured to perform signal processing to determine tension and/or loading information of a cable based on a measured vibration state(s), according to aspects of the present disclosure. In some cases, by using neural network architectures in determining one or more correlations and/or relationships between vibration states measured for a cable and tension or loading experienced by the cable during the measured vibration states, aspects of the present disclosure can increase the accuracy and efficiency of determining and controlling cable tensioning and/or loading.

In general, ML can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

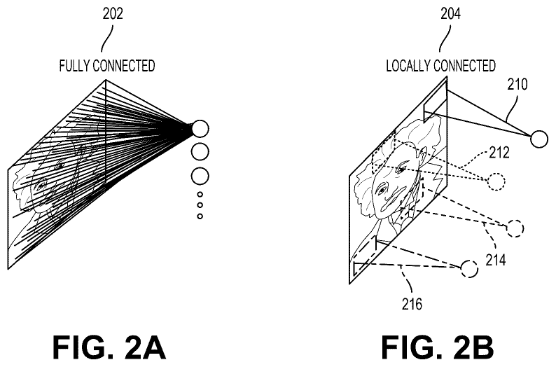

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, as the higher layer neurons in a given region may receive inputs that are tuned through training to the properties of a restricted portion of the total input to the network.

As noted previously, cables can be used to transmit tensile forces between components that are connected to the cable (e.g., often connected to the ends of the cable via a respective termination provided at each end of the cable). Cables are used in a wide variety of environments and deployment scenarios, which can include, but are not limited to, maritime environments, shore or land-based environments, sub-sea or sub-surface environments, etc. In the context of the present disclosure, reference is made to the example of cables deployed in a maritime environment, although it is noted that this is done for purposes of illustration and example and is not intended to be construed as limiting (e.g., although described with reference to cables deployed in maritime environments, the systems and techniques described herein may also be utilized with cables deployed in non-maritime environments, without departing from the scope of the present disclosure).

Determining load information of a cable can be useful for characterizing the fatigue or wear experienced by a cable, for example over the course of a particular deployment and/or over the course of the lifetime of the cable. Determining load information of a cable can also be useful for determining or otherwise estimating a remaining useful lifetime of a cable, such that a cable's remaining useful lifetime expires prior to the cable experiencing a failure. As used herein, the terms “load” and “loading” may be used interchangeably with the terms “tension” and “tensioning,” respectively, and may be collectively referred to as “load information” or “loading information” of the cable.

Fatigue, wear, and remaining useful lifetime of a cable can depend in large part on the loading (e.g., tensioning) that is applied to the cable. For example, the quantity of loading cycles experienced by a cable, and the magnitude of each respective loading cycle, can significantly impact the fatigue, wear, and remaining useful lifetime of the cable. As such, there is a need to accurately and efficiently determine loading information for cables. There is a further need to determine loading information over time, for instance determining when tension is applied to a cable and how (or if) the applied tension changes over time.

There is a further need to accurate and efficiently determine cable loading information in order to drive or otherwise enable more efficient cable management practices. For instance, there is a need to provide better power control for sensors that are configured to obtain measurements only while a cable is in use or otherwise under load.

Existing and current approaches to determining load information of a cable are commonly based on the use of strain sensors, which can be used to measure a strain of the cable. Recalling that mechanical strain can be used to measure the deformation in a material when mechanical stress is applied (e.g., with strain typically determined as cane

$$\frac{Change in length}{Original length} = \frac{Δ L}{L} ) ,$$

conventional approaches estimate the force (e.g., load) acting on a cable based on the deformation measured by the strain sensors. Because strain sensors must measure a physical deformation of the cable, strain sensors must be used in the load path of the cable. In other words, to determine load information of a cable using strain sensors, the strain sensors must be directly coupled to the cable. The coupling to the cable must be done while the cable is not loaded due to practical and safety considerations. This requirement limits when a strain sensor can be installed and also creates difficulties to add strain sensors to existing systems and conduct calibrations and replacements. Strain sensors used to determine loading information of cables are also often power-intensive and bulky.

Accordingly, there is a need for systems and techniques that can be used to more efficiently and effectively determine loading information of a cable, without requiring the use of a strain sensor. There is also a need for systems and techniques that can be used to determine loading information of a cable without using sensors that are integral to the cable, and without using sensors that must be provided in the load path of the cable. These problems and more are addressed by aspects of the present disclosure, as will be described in greater depth below.

Systems, apparatuses, processes (also referred to as methods), and computer-readable media (collectively referred to as “systems and techniques”) are described herein for determining loading information of a cable based on vibration information of the cable. For instance, one or more accelerometers can be used to determine a vibration state of a cable, and an estimated loading associated with the cable can be determined based on the vibration state. In some cases, the vibration state can be a time series of accelerometer measurements obtained from an accelerometer associated with the cable. As used herein, a “vibration state” and/or “vibration information” may include harmonics information associated with (e.g., corresponding to) the vibration and/or vibratory movement of the cable. For example, a vibration state can include one or more (or all) of accelerometer information and/or time series accelerometer measurements for the vibration of the cable; displacement information and/or position information for the vibration of the cable, including both derived or directly obtained measurements; harmonics and/or derived harmonic information for the vibration of the cable; etc. The harmonics and/or derived harmonic information for the vibration of the cable may be indicative of information such as amplitude, phase, etc., of sinusoidal components or waves at integer multiples of a fundamental frequency. Harmonics information for vibration of a cable can additionally, or alternatively, be indicative of various harmonic patterns and features, such as harmonic distortion, harmonic resonances, etc., among various other vibrational behaviors and harmonic features. In another example, the vibration state can be a pattern of vibration behavior and/or a type of vibration behavior identified based on analyzing a time series of accelerometer measurements obtained from an accelerometer associated with the cable.

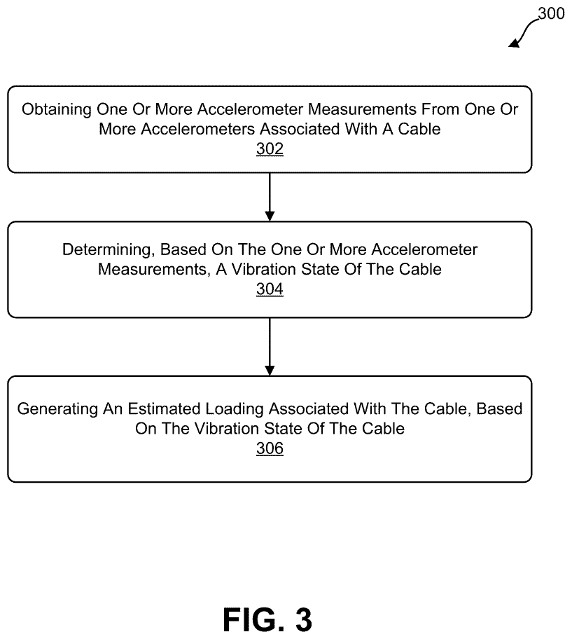

FIG. 3 is a flow diagram illustrating an example of a process 300 for determining estimation loading state information associated with a cable, in accordance with some examples. In one illustrative example, at block 302 the process 300 includes obtaining one or more accelerometer measurements from one or more accelerometers associated with a cable. For example, in some embodiments, one or more accelerometers can be placed on or otherwise attached to a cable, such that the cable vibration is coupled to the accelerometer. For instance, an accelerometer can be rigidly affixed (in a permanent, semi-permanent, or removable fashion) to an external surface of a cable, such that the accelerometer does not experience relative motion with respect to the cable. In other words, the accelerometer can be attached to the cable such that the accelerometer experiences (and therefore, measures) the same vibration(s) as the cable itself. An accelerometer may additionally, or alternatively, be attached to various hardware components that are associated with a cable and/or that are themselves coupled to a cable. For example, an accelerometer can be attached to or otherwise integrated with hardware components that can include, but are not limited to, shackles, thimbles, rope terminations, etc.

In some aspects, an accelerometer can be coupled to and/or included in one or more sensor housings or sensor modules associated with a cable. For example, the accelerometer can be provided in a sensor housing or sensor module that is integrated in or coupled to an end termination of the cable and/or an intermediate location on the cable (e.g., between the two end terminations). In some cases, the sensor housing/module can include components such as a battery or power source (e.g., for providing electrical power to the accelerometer), a processor (e.g., for performing pre-processing and/or processing of accelerometer data), a communications interface (e.g., wired or wireless, for communicatively coupling the accelerometer and accelerometer data to one or more receivers), a data storage element, etc.

In some aspects, the one or more accelerometers used to determine loading information of a cable can be associated with one or more transceivers and/or communications interfaces. For instance, in the example describe above in which an accelerometer is included in a sensor housing or sensor module, the accelerometer can be associated with a transceiver or communication interface of the sensor housing. In examples in which an accelerometer is provided separate from a sensor housing or module, the accelerometer may be associated with one or more wired or wireless communications interfaces (e.g., transceivers) that are also provided separate from the sensor housing. It is also possible for accelerometers that are provided separate from a sensor housing may utilize a communications interface of the sensor housing for transmitting their corresponding accelerometer measurements. For instance, accelerometers attached to the cable can communicate, wired or wirelessly, with the sensor housing, and the sensor housing can subsequently communicate the accelerometer measurements to a corresponding receiver of the accelerometer data. In this example, the distance between the accelerometers on the cable and the communications interface of the sensor housing can be less than the distance between the sensor housing and a top-side receiver that processes and analyzes the accelerometer data. The top-side receiver can also be referred to as a surface receiver, and may be provided on a boat, platform, or other vessel located in or near the environment in which the cable and accelerometers are deployed.

For instance, accelerometer data measured by the one or more accelerometers can be transmitted (e.g., in wired and/or wireless fashion) to a surface receiver associated with the deployment of the cable to which the accelerometers are attached. For instance, when a cable is deployed using a winch and/or reel (e.g., mounted on a surface vessel), the accelerometer data can be received using a receiver associated with the cable winch and/or reel. In some embodiments, the accelerometer data can be transmitted to the surface using wireline communications. The wireline can be provided as an electrically conductive cable or filament and/or can be provided as a fiber optic cable or filament, etc. In some aspects, a communications wireline can be included in, integrated in, or otherwise provided by the cable to which the accelerometers are affixed and used to measure vibration states. In other examples, a wireline communication cable can be affixed or otherwise coupled to an outer surface of the cable, in order to provide wired communications (unidirectional or bi-directional) between the one or more accelerometers and a corresponding surface receiver.

In some embodiments, the one or more accelerometers can measure and transmit accelerometer data (e.g., corresponding to movements and/or vibrations of the cable to which the accelerometers are coupled) in substantially real-time. Based on receiving the substantially real-time accelerometer data, a processor (e.g., coupled to the cable and associated with the accelerometers, coupled to and associated with the surface receiver receiving the transmitted accelerometer data, or both) can analyze the accelerometer data to determine vibration state information (e.g., which may comprise and/or include harmonics information and harmonic features, etc.) and loading state information of the cable in substantially real time as well.

In some aspects, the one or more accelerometers can measure accelerometer data in substantially real time (either continuously or for one or more pre-determined time intervals), log or store the real time accelerometer data, and transmit the logged/stored accelerometer data periodically for analysis and cable loading state determination. For example, the accelerometers can be configured to transmit their measured accelerometer data (e.g., vibration data) of the cable on a periodic basis, such as every 5 minutes, every 10 minutes, etc. In some embodiments, the accelerometers can measure and store accelerometer data of the cable, which can be retrieved or otherwise communicated for analysis in an on-demand fashion (e.g., transmitted in response to a request for the most recently obtained accelerometer data over some period of time). The periodicity of accelerometer data measurement can be greater than the periodicity of reporting and/or analyzing the measured accelerometer data. In other examples, the periodicity of accelerometer data measurement can be the same as the periodicity of reporting and/or analyzing the measured accelerometer data.

In some cases, multiple accelerometers can be utilized to perform load monitoring and/or load state determination for a cable. The multiple accelerometers can be the same as one another and/or can be different from one another. For example, a first subset of accelerometers can be provided that are coupled to a fixed location on the cable (e.g., such as at or within the end termination(s) of the cable, a midpoint of the cable, etc.) while a second subset of accelerometers can be provided that are adjustably moveable between various locations and positions about the external surface of the cable (e.g., between the end terminations). The first subset of accelerometers can be of a first type of accelerometer, while the second subset of accelerometers may be of a second type that is different from the first type. For instance, the first subset of accelerometers can be accelerometers configured for permanent or semi-permanent coupling to a cable, while the second subset of accelerometers can be accelerometers configured for temporary, removable, and/or re-adjustable coupling to a cable.

While reference is made herein to an example in which one or more accelerometers are used to determine vibration state information of a cable, it is noted that this is provided for purposes of illustration and example, and is not intended to be construed as limiting. In some embodiments, various other vibration and/or acceleration sensors (e.g., besides accelerometers) can be utilized to determine vibration state information of a cable, without departing from the scope of the present disclosure. For example, vibration state information of a cable (e.g., including harmonics and/or harmonic features, etc.) can be measured or otherwise determined using one or more lasers, using fiber optics, etc. In some embodiments, one or more fiber optic accelerometers (FOAs) can be utilized. A fiber optic accelerometer is an opto-mechanical acceleration sensor, which uses a micromechanical silicon mirror (MEMS) to deflect a light beam proportional to the acceleration of the fiber optic accelerometer. In some aspects, fiber optic accelerometers can be used to obtain accelerometer data and/or vibration state information in harsh or rugged environments, and may be separated from measurement electronics by optical fibers. In other examples, one or more mechanical accelerometers may additionally, or alternatively, be utilized. A mechanical accelerometer can perform an electrical, piezoelectric, piezoresistive, and/or capacitive measurement to determine or otherwise obtain the accelerometer data described herein. For instance, a mechanical accelerometer can be provided as a micro-electro-mechanical system (MEMS). Mechanical accelerometers can also include thermal (e.g., convective accelerometers).

In the examples described above, accelerometer data and/or vibration state information of the cable is measured directly, for example by using an accelerometer or other sensor that is mechanically coupled to the cable such that the accelerometer/sensor experiences the same movement as the cable. In such examples, the movements of the accelerometer can be assumed to be the same as the movements of the cable (e.g., based on the accelerometer/sensor being rigidly coupled to the cable so as to not experience relative motion with respect to the cable body).

In other examples, one or more sensors can be utilized to perform secondary measurements or sensing of acceleration, vibration, and/or other movement(s) of a cable. In such examples, the one or more vibration sensors can be separate from or otherwise external to the cable being measured, such that the vibration or movement of the cable is measured remotely. For instance, secondary or remote vibration sensors can include, but are not limited to, laser-based sensors and sensing techniques. For example, in some embodiments, the systems and techniques described herein can utilize one or more non-contact, remote sensing laser vibrometers, laser displacement meters, and/or laser doppler vibrometers (LDVs) for collecting cable vibration data. In some aspects, remote sensing laser vibrometers can collect cable vibration data from distances of up to several hundreds of feet, and may measure dynamic characteristics of the cable including vibration frequencies, magnitudes, damping ratios, etc. Cable parameters and other material information of the cable can be used to calculate a cable force (e.g., tension or cable loading, etc.).

Notably, the systems and techniques described herein can obtain accelerometer data and/or vibration state information of a cable using one or more accelerometers (or other vibration sensors) that are not required to be coupled in the load path of the cable. As noted previously, existing and current approaches to determining load information of a cable are commonly based on the use of strain sensors, which can be used to measure a strain of the cable. Because strain sensors operate on the principal of measuring the physical deformation in a material when mechanical stress is applied (e.g., based on strain=ΔL/L), strain sensors must be used in the load path of the cable. In other words, to determine load information of a cable using strain sensors, the strain sensors must be directly coupled to the cable. Most commonly, the strain sensors must be integrated or woven into the strands of the cable (e.g., cannot be attached externally to the cable), and therefore cannot be placed or removed from a cable while the cable is under load. Strain sensors used to determine loading information of cables are also often power-intensive and bulky.

Advantageously, the one or more accelerometers described herein do not need to be integrated in the load path of the cable in order to obtain accelerometer data and/or vibration state information of the cable. In one illustrative example, an accelerometer can be placed at various locations along the outer surface of a cable, and various different mounting techniques and/or mounting hardware may be utilized, so long as the accelerometer is rigidly affixed to the cable. Accordingly, because an accelerometer can be affixed to the outside of a cable, an accelerometer can be added and removed from a system while it is under load. In other words, whereas conventional strain sensor based approaches require a cable to be unloaded in order to add, remove, or modify a strain sensor used to determine loading state information of the cable, the accelerometers described herein can be added, removed, or modified without disruption to the operation, deployment, or other use of the cable (e.g., because the cable can remain under load while an accelerometer is attached, detached, moved, adjusted, swapped, etc.). Moreover, compared to conventional strain sensors used for cable load state monitoring, the presently disclosed accelerometer-based approach can utilize one or more accelerometers that are physically smaller and have lower power requirements than the conventional strain sensors—thereby permitting a lower upfront capital expenditure and a lower ongoing/operating expense in terms of electrical power supply. Accelerometers can also be of a lower cost than the conventional strain sensors for determining cable loading information. Based on their low cost and small physical footprint, accelerometers can also be incorporated into various components, whether components of a cable itself (e.g., sensor housings/modules, end terminations, shackles, thimbles, etc.) or components associated with deployment of the cable.

At block 304, the process 300 can include determining, based on the one or more accelerometer measurements, a vibration state of the cable. As noted above, the measured vibration state of the cable can be determined using one or more accelerometers and/or can be determined using one or more secondary measurement (e.g., non-contact) sensing devices and techniques.

The vibration behavior of a cable can change based on the loading characteristics of the cable. For instance, a cable that is under tension (e.g., experiencing load) can vibrate at a greater and more consistent frequency than a cable that is not under tension. Similarly, in some cases, a vibration frequency of a cable may increase proportional to the load of the cable (e.g., all else equal). In general, it is noted that as a load is applied to a cable, a vibration frequency of the cable will change. As the applied load increases, the vibration frequency of the cable will continue to increase (e.g., among other changes in vibration state behavior, including changes in vibration magnitude, damping, harmonics, etc.).

In one illustrative example, based on measuring or otherwise determining one or more changes in the vibration behavior of a cable (e.g., using the measured vibration state information of the cable), the systems and techniques described herein can estimate or infer changes in the loading state information of the cable. For example, one or more processors can be used to analyze measured vibration state information of a cable over time, and identify changes in vibration state to determine corresponding changes in load state information of the cable.

At block 306, the process 300 includes generating an estimated loading associated with the cable, based on the vibration state of the cable. For instance, measured vibration state information of a cable can be analyzed and used to generate an indication of a no-load state based on detecting a no-load state of the cable (e.g., no external tension applied to the cable). In some aspects, the no-load state of the cable can correspond to detecting a first vibration state of the cable. The first vibration state of the cable can be a baseline vibration state and/or an ambient vibration state of the cable (e.g., based on material properties and characteristics of the particular cable being measured, based on environmental factors or conditions, etc.). In some embodiments, the systems and techniques can generate an indication of a loaded state based on detecting a second vibration state of the cable, wherein the second vibration state is different than the first (e.g., no-load) vibration state of the cable.

In some embodiments, the second vibration state can be indicative of the cable being in a loaded state (e.g., at all times, the cable can be considered either in the first, no-load vibration state or in the second, loaded vibration state, with greater granularity of the loaded vibration state(s) described in greater depth below). In some examples, the second vibration state can be determined based on the measured vibration data of the cable exceeding one or more pre-determined thresholds and/or based on some (or all) of the measured and analyzed vibration characteristic parameters deviating from the baseline first vibration state (no-load state) by greater than a pre-determined percentage.

In some examples, changes in the loading state information of a cable can be identified, determined, or otherwise inferred based on analyzing an observed change in the measured vibration state information of the cable. For instance, the observed change in the measured vibration state information of the cable can be analyzed against a database of known examples of correlated vibration state-loading state information pairs for a cable. The correlated vibration state-loading state information pairs can be specific to particular types of cables and/or particular mechanical or physical properties of cables. In other examples, the correlated vibration state-loading state information may additionally, or alternatively, be generic to multiple different types of cables and/or multiple different mechanical or physical properties (e.g., ranges thereof) of cables. In some cases, one or more machine learning networks can be trained and utilized to determine a loading state of a cable based on receiving as input measured vibration state information obtained for the cable. For instance, the one or more machine learning networks can be trained using training data comprising labeled vibration state measurement information and/or labeled time series of vibration state measurement information. The training data can be labeled with a ground-truth loading state of a corresponding cable at the time the vibration state training data was measured and/or with a ground-truth loading state change of the corresponding cable at the time a time-series vibration state training data was measured.

In some embodiments, the systems and techniques described herein can analyze measured vibration state information of a cable (and changes in measured vibration state information of a cable) to determine if a cable system is under load, as described above. Additionally, the measured vibration state information of a cable (and changes thereof) can be analyzed to determine if the load state of the cable is changing or is constant. For instance, in addition to generating an indication that a cable has transitioned from being in a no-load state to now being in a loaded state, an indication can be generated when the load on a cable increases or decreases. More generally, it is contemplated that measured vibration state information can be analyzed to generate various indications of any change in the loading state information of a cable, whether the change is from a no-load state to a loaded state, an increase in load while in a loaded state, a decrease in load while in a loaded state, etc. Indications can be generated, in some examples, based on a determined change in the loading state information of the cable exceeding one or more pre-determined thresholds. For instance, the pre-determined thresholds can indicate a maximum allowable (e.g., before generating a notification or indication of the change) change in absolute value of cable load, increase in cable load, decrease in cable load, etc. The pre-determined thresholds can additionally or alternatively indicate maximum allowable rates of change (e.g., maximum allowable before generating a notification or indication that the pre-determined rate has been exceeded). In some examples, a notification or indication can be generated responsive to determining, based on the measured vibration state information of the cable, that the loading on the cable has increased at a rate that exceeds a pre-determined threshold for the maximum allowable rate of change in load. Different thresholds can be used over different periods of time. For example, a maximum allowable rate of change in load over a is or 5 s window may be greater than a maximum allowable rate of change in load over a 1 min or 5 min window, or vice versa, etc.

In some aspects, the measured vibration state information can be analyzed to determine a magnitude of an estimated loading currently acting on or otherwise experienced by the cable. The magnitude of the estimated loading can be determined based on a combination of the various vibration characteristics measured for the cable and/or based on material or physical properties of the cable (e.g., such as mass, length, diameter, material composition, surrounding deployment environment, load type, etc.). In one illustrative example, the estimated loading state information of a cable can be used to control one or more cable management processes. For instance, one or more accelerometers disposed on the cable can be monitored to determine whether the cable is in a loaded state or an un-loaded state. When it is determined that the cable is in an un-loaded state, the systems and techniques can be configured to automatically turn off one or more other sensors that are associated with the cable. For instance, when an un-loaded state is detected (e.g., transitioning from a loaded state of the cable), sensors that obtain useful sensor data only while the cable system is under load can be automatically powered off. Similarly, when a loaded state is detected (e.g., transitioning from an un-loaded state of the cable), sensors that obtain useful sensor data only while the cable system is under load can be automatically powered on and configured to obtain and/or transmit their sensor data for further processing or subsequent action. This dynamic control of sensing related to the cable experiencing load or tension can be seen to improve the efficiency of cable systems, based at least in part on conserving battery power by turning off or otherwise idling sensors when sensor data collection is not needed or would be unnecessary (e.g., when the cable transitions to an un-loaded state).

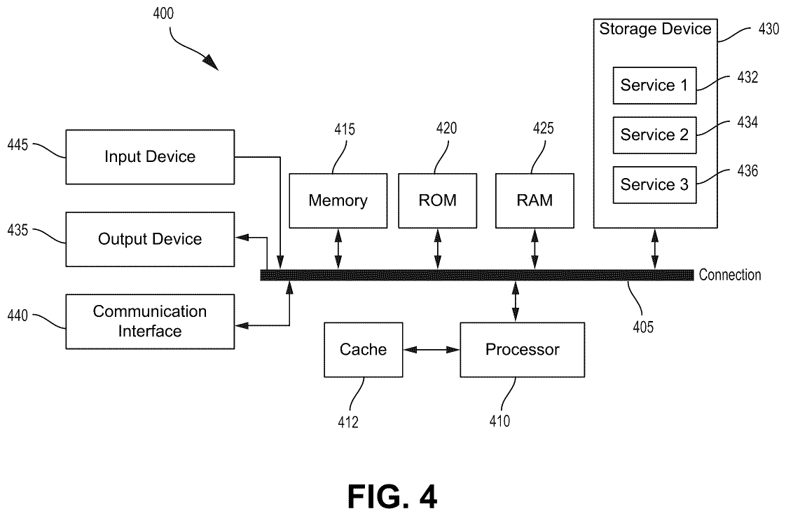

FIG. 4 illustrates a computing system architecture, according to some embodiments of the present disclosure. Components of computing system architecture 400 are in electrical communication with each other using a connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random-access memory (RAM) 425 to processor 410. Computing system 400 can include a cache of high-speed memory 412 connected directly with, in close proximity to, or integrated as part of processor 410.

Processor 410 can include any general-purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative aspects of the disclosure include:

Aspect 1. A method comprising: obtaining one or more accelerometer measurements from one or more accelerometers associated with a cable; determining, based on the one or more accelerometer measurements, a vibration state of the cable; and generating an estimated loading associated with the cable, based on the vibration state of the cable.

Aspect 2. The method of Aspect 1, wherein generating the estimated loading associated with the cable comprises: generating an indication of a no-load state based on detecting a first vibration state of the cable; and generating an indication of a loaded state based on detecting a second vibration state of the cable.

Aspect 3. The method of any of Aspects 1 to 2, wherein generating the estimated loading associated with the cable is based on determining one or more changes in a vibration state associated with the cable.

Aspect 4. The method of Aspect 3, wherein generating the estimated loading associated with the cable comprises: generating an indication of a loaded state based on determining a first type of vibration behavior change between an initial vibration state of the cable and a subsequent vibration state of the cable; and generating an indication of a no-load state based on determining a second type of vibration behavior change between the initial vibration state of the cable and a subsequent vibration state of the cable, wherein the second type of vibration behavior change is different than the first type of vibration behavior change.

Aspect 5. The method of any of Aspects 1 to 4, wherein generating the estimated loading associated with the cable comprises: determining a first estimated loading associated with the cable at a first time; determining a second estimated loading associated with the cable at a second time after the first time; and generating an indication of a loading change between the first time and the second time.

Aspect 6. The method of Aspect 5, wherein the indication of the loading change between the first time and the second time is indicative of an increase or a decrease in loading associated with the cable.

Aspect 7. The method of any of Aspects 5 to 6, wherein the indication of the loading change between the first time and the second time is indicative of one or more of a percentage change in loading associated with the cable between the first time and the second time and a tension change associated with the cable between the first time and the second time.

Aspect 8. The method of any of Aspects 1 to 7, wherein generating the estimated loading associated with the cable comprises determining an estimated tension of the cable.

Aspect 9. The method of any of Aspects 1 to 8, further comprising generating one or more tension estimates associated with the cable, wherein the one or more tension estimates are generated based on the vibration state of the cable.

Aspect 10. The method of any of Aspects 1 to 9, wherein the one or more accelerometer measurements comprises a plurality of accelerometer measurements, each respective accelerometer measurement included in the plurality of accelerometer measurements associated with a different time.

Aspect 11. The method of Aspect 10, wherein the vibration state of the cable comprises one or more of a change in vibration frequency over time and a change in vibration amplitude over time.

Aspect 12. The method of any of Aspects 2 to 11, further comprising: activating one or more sensors associated with the cable based on generating the indication of the loaded state; and deactivating the one or more sensors associated with the cable based on generating the indication of the no-load state.

Aspect 13. The method of any of Aspects 2 to 12, further comprising: determining an elapsed time between generating the indication of the loaded state and generating the indication of the no-load state; and updating a first timer value using the elapsed time, wherein the first timer value is indicative of a time under load associated with the cable.

Aspect 14. The method of any of Aspects 1 to 13, wherein the one or more accelerometer measurements are obtained from one or more accelerometers detachably coupled to the cable.

Aspect 15. The method of Aspect 14, wherein the one or more accelerometers are not included in a load path associated with the cable.

Aspect 16. The method of any of Aspects 1 to 15, wherein the one or more accelerometer measurements are obtained from one or more accelerometers included in a sensor housing detachably coupled to the cable.

Aspect 17. The method of any of Aspects 1 to 16, wherein the one or more accelerometer measurements are obtained from one or more accelerometers included in the cable.

Aspect 18. The method of any of Aspects 1 to 17, wherein the one or more accelerometer measurements are obtained from one or more accelerometers included in an end termination of the cable.

Aspect 19. An apparatus, the apparatus comprising: at least one memory; and at least one processor coupled to the at least one memory, the at least one processor being configured to: obtain one or more accelerometer measurements from one or more accelerometers associated with a cable; determine, based on the one or more accelerometer measurements, a vibration state of the cable; and generate an estimated loading associated with the cable, based on the vibration state of the cable.

Aspect 20. The apparatus of Aspect 19, wherein, to generate the estimated loading associated with the cable, the at least one processor is configured to: generate an indication of a no-load state based on detecting a first vibration state of the cable; and generate an indication of a loaded state based on detecting a second vibration state of the cable.

Aspect 21. The apparatus of any of Aspect 19 to 20, wherein the at least one processor is configured to generate the estimated loading associated with the cable based on determining one or more changes in a vibration state associated with the cable.

Aspect 22. The apparatus of Aspect 21, wherein, to generate the estimated loading associated with the cable, the at least one processor is configured to: generate an indication of a loaded state based on determining a first type of vibration behavior change between an initial vibration state of the cable and a subsequent vibration state of the cable; and generate an indication of a no-load state based on determining a second type of vibration behavior change between the initial vibration state of the cable and a subsequent vibration state of the cable, wherein the second type of vibration behavior change is different than the first type of vibration behavior change.

Aspect 23. The apparatus of any of Aspects 19 to 22, wherein, to generate the estimated loading associated with the cable, the at least one processor is configured to: determine a first estimated loading associated with the cable at a first time; determine a second estimated loading associated with the cable at a second time after the first time; and generate an indication of a loading change between the first time and the second time.

Aspect 24. The apparatus of Aspect 23, wherein the indication of the loading change between the first time and the second time is indicative of an increase or a decrease in loading associated with the cable.

Aspect 25. The apparatus of any of Aspects 23 to 24, wherein the indication of the loading change between the first time and the second time is indicative of one or more of a percentage change in loading associated with the cable between the first time and the second time and a tension change associated with the cable between the first time and the second time.

Aspect 26. The apparatus of any of Aspects 19 to 25, wherein, to generate the estimated loading associated with the cable, the at least one processor is configured to determine an estimated tension of the cable.

Aspect 27. The apparatus of any of Aspects 19 to 26, wherein the at least one processor is further configured to generate one or more tension estimates associated with the cable, wherein the one or more tension estimates are generated based on the vibration state of the cable.

Aspect 28. The apparatus of any of Aspects 19 to 27, wherein the one or more accelerometer measurements comprises a plurality of accelerometer measurements, each respective accelerometer measurement included in the plurality of accelerometer measurements associated with a different time.

Aspect 29. The apparatus of Aspect 28, wherein the vibration state of the cable comprises one or more of a change in vibration frequency over time and a change in vibration amplitude over time.

Aspect 30. The apparatus of any of Aspects 20 to 29, wherein the at least one processor is further configured to: activate one or more sensors associated with the cable based on generating the indication of the loaded state; and deactivate the one or more sensors associated with the cable based on generating the indication of the no-load state.

Aspect 31. The apparatus of any of Aspects 20 to 30, wherein the at least one processor is further configured to: determine an elapsed time between generating the indication of the loaded state and generating the indication of the no-load state; and update a first timer value using the elapsed time, wherein the first timer value is indicative of a time under load associated with the cable.

Aspect 32. The apparatus of any of Aspects 19 to 31, wherein the one or more accelerometer measurements are obtained from one or more accelerometers detachably coupled to the cable.

Aspect 33. The apparatus of Aspect 32, wherein the one or more accelerometers are not included in a load path associated with the cable.

Aspect 34. The apparatus of any of Aspects 19 to 33, wherein the one or more accelerometer measurements are obtained from one or more accelerometers included in a sensor housing detachably coupled to the cable.

Aspect 35. The apparatus of any of Aspects 19 to 34, wherein the one or more accelerometer measurements are obtained from one or more accelerometers included in the cable.

Aspect 36. The apparatus of any of Aspects 19 to 35, wherein the one or more accelerometer measurements are obtained from one or more accelerometers included in an end termination of the cable.

Aspect 37. A non-transitory computer-readable medium having stored thereon instructions which, when executed by one or more processors, cause the one or more processors to perform operations comprising: obtaining one or more accelerometer measurements from one or more accelerometers associated with a cable; determining, based on the one or more accelerometer measurements, a vibration state of the cable; and generating an estimated loading associated with the cable, based on the vibration state of the cable.

Aspect 38. An apparatus comprising means for performing any of the operations of Aspects 1 to 18.

Aspect 39. An apparatus comprising means for performing any of the operations of Aspects 19 to 36.

Aspect 40. A non-transitory computer-readable storage medium having stored thereon instructions which, when executed by one or more processors, cause the one or more processors to perform any of the operations of Aspects 1 to 18.

Aspect 41. A non-transitory computer-readable storage medium having stored thereon instructions which, when executed by one or more processors, cause the one or more processors to perform any of the operations of Aspects 19 to 36.

What is claimed is:

1. A method comprising:
obtaining one or more accelerometer measurements from one or more accelerometers associated with a cable;
determining, based on the one or more accelerometer measurements, a vibration state of the cable; and
generating an estimated loading associated with the cable, based on the vibration state of the cable.

2. The method of claim 1, wherein generating the estimated loading associated with the cable comprises:
generating an indication of a no-load state based on detecting a first vibration state of the cable; and
generating an indication of a loaded state based on detecting a second vibration state of the cable.

3. The method of claim 1, wherein generating the estimated loading associated with the cable is based on determining one or more changes in a vibration state associated with the cable.

4. The method of claim 3, wherein generating the estimated loading associated with the cable comprises:
generating an indication of a loaded state based on determining a first type of vibration behavior change between an initial vibration state of the cable and a subsequent vibration state of the cable; and
generating an indication of a no-load state based on determining a second type of vibration behavior change between the initial vibration state of the cable and a subsequent vibration state of the cable, wherein the second type of vibration behavior change is different than the first type of vibration behavior change.

5. The method of claim 1, wherein generating the estimated loading associated with the cable comprises:
determining a first estimated loading associated with the cable at a first time;
determining a second estimated loading associated with the cable at a second time after the first time; and
generating an indication of a loading change between the first time and the second time.

6. The method of claim 5, wherein the indication of the loading change between the first time and the second time is indicative of an increase or a decrease in loading associated with the cable.

7. The method of claim 5, wherein the indication of the loading change between the first time and the second time is indicative of one or more of a percentage change in loading associated with the cable between the first time and the second time and a tension change associated with the cable between the first time and the second time.

8. The method of claim 1, wherein generating the estimated loading associated with the cable comprises determining an estimated tension of the cable.

9. The method of claim 1, further comprising generating one or more tension estimates associated with the cable, wherein the one or more tension estimates are generated based on the vibration state of the cable.

10. The method of claim 1, wherein the one or more accelerometer measurements comprises a plurality of accelerometer measurements, each respective accelerometer measurement included in the plurality of accelerometer measurements associated with a different time.

11. The method of claim 10, wherein the vibration state of the cable comprises one or more of a change in vibration frequency over time and a change in vibration amplitude over time.

12. The method of claim 2, further comprising:
activating one or more sensors associated with the cable based on generating the indication of the loaded state; and
deactivating the one or more sensors associated with the cable based on generating the indication of the no-load state.

13. The method of claim 2, further comprising:
determining an elapsed time between generating the indication of the loaded state and generating the indication of the no-load state; and
updating a first timer value using the elapsed time, wherein the first timer value is indicative of a time under load associated with the cable.

14. The method of claim 1, wherein the one or more accelerometer measurements are obtained from one or more accelerometers detachably coupled to the cable.

15. The method of claim 14, wherein the one or more accelerometers are not included in a load path associated with the cable.

16. The method of claim 1, wherein the one or more accelerometer measurements are obtained from one or more accelerometers included in a sensor housing detachably coupled to the cable.

17. The method of claim 1, wherein the one or more accelerometer measurements are obtained from one or more accelerometers included in the cable.

18. The method of claim 1, wherein the one or more accelerometer measurements are obtained from one or more accelerometers included in an end termination of the cable.

19. An apparatus, the apparatus comprising:
at least one memory; and
at least one processor coupled to the at least one memory, the at least one processor being configured to:
obtain one or more accelerometer measurements from one or more accelerometers associated with a cable;
determine, based on the one or more accelerometer measurements, a vibration state of the cable; and
generate an estimated loading associated with the cable, based on the vibration state of the cable.

20. A non-transitory computer-readable medium having stored thereon instructions which, when executed by one or more processors, cause the one or more processors to perform operations comprising:
obtaining one or more accelerometer measurements from one or more accelerometers associated with a cable;
determining, based on the one or more accelerometer measurements, a vibration state of the cable; and
generating an estimated loading associated with the cable, based on the vibration state of the cable.
